(19) United States
(12) Patent Application Publication
(10) Pub. No.: US 2007/0290079 A1
(43) Pub. Date: Dec. 20, 2007

(54) Body for a Nozzle Arrangement

(76) Inventor: Keith Laidler, West Midlands (GB)

Correspondence Address: PEARSON & PEARSON, LLP, 10 GEORGE STREET, LOWELL, MA, 01852, US

(21) Appl. No.: 11/597,014

(22) PCT Filed: May 19, 2005
(86) PCT No.: PCT/GB05/01932

§ 371 Date: Jul. 20, 2007

(30) Foreign Application Priority Data
May 20, 2004 (GB) 0411329.6

(51) Int. Cl. B05B 1/00

(52) U.S. Cl. 239/590

(57) ABSTRACT

A body (100) for a nozzle arrangement includes two parts (106, 107) that can be assembled together to form at least part of the body. Each of the parts has an abutment surface (108, 109) adapted to contact a corresponding abutment surface (108, 109) on the other of said parts when the parts are assembled. The parts also have corresponding formations (110, 111) that co-operate to define between them an outlet (102) and at least a portion of an internal passageway (103) connecting the outlet to an inlet (101) when the parts are assembled. A first of said parts (106) comprises at least one filter projection (104) extending towards a second of said parts (107). The second of said parts (107) has at least ane filter formation (103a) that co-operates with the least owe filter projection (104) to form a filter in the passageway. The at least one filter formation may be a recess (103a) or may be one of more projections extending from the second part towards the first part.

This invention relates to a body for a nozzle arrangement which body incorporates a filter. The invention also relates to a nozzle arrangement incorporating such a body.

It is often desirable to be able to filter out particulate matter/debris from a fluid stream as it is dispensed through a nozzle arrangement. However, one drawback associated with positioning a filter, such as, for example, a mesh, within a nozzle arrangement is the increased production arising from the cost of the mesh component and the extra assembly processes involved.

It is known from U.S. Pat. No. 5,911,851 to form a nozzle arrangement for very high pressure fluids from silicon or a metallic material. In this arrangement, a channel is etched in a first plate and a second plate is positioned on top of the first closing off the channel to form an internal fluid flow passageway. An integral filter is formed by etching a series of small parallel groves in the first plate through which the fluid must pass to reach the outlet. Whilst this arrangement may be suitable for certain specialised applications, most nozzles are required for use with fluids at a pressure of 20 bars or less and are manufactured in high volumes from plastic. Such applications tend to be very cost sensitive and so the nozzle arrangements and methods of manufacture described in U.S. Pat. No. 5,911,851 would be unsuitable.

US 2001/0019086 discloses a fluidic oscillator incorporating a nozzle with a built-in filter. The oscillator comprises a so called “circuit chip” and a housing for receiving the chip, both of which are moulded from plastic. A channel is defined in an outer surface of the chip to form a fluid passage when the chip is inserted into the housing. A number of posts are provided across the channel to form a filter for the fluid passing through the passage. Whilst this arrangement provides for an integral filter, the minimum spacing between the posts is limited. Typically, when moulding a nozzle of this type pins are used in the mould to create the spaces between the posts. Such pins will usually be at least, 1 mm in length and if they are less than about 0.3 mm in width/diameter, they would tend to break regularly, making volume production almost impossible. Consequently, this type of nozzle filter arrangement is not effective where a very fine filter is required. Furthermore, the arrangements shown are only capable of providing a relatively limited number of filter configurations.

There is a requirement, therefore, for a simple and cost effective nozzle arrangement design that incorporates an integral filter and which overcomes or at least mitigates the problems associated with the prior art.

According to a first aspect of the invention, there is provided a body for a nozzle arrangement as defined in claim 1. Further aspects of the invention are to be found in the claims dependent on claim 1.

According to a second aspect of the invention, there is provided a nozzle arrangement incorporating a body in accordance with the first aspect.

The body and filter arrangements of the invention may be used with any nozzle arrangement, including, for example, industrial nozzle arrangements, pump and trigger-actuated nozzle arrangements, and nozzle arrangements used with pressurised aerosol canisters. Furthermore, the body and filter arrangements of the invention and can be adapted for use with any fluid or combinations of fluids having any given viscosity. Accordingly, the body and filter arrangements can be used in or with nozzles adapted for use in dispensing a large number of commercial products, including, for example, antiperspirant sprays, de-odorant sprays, perfumes, air fresheners, antiseptics, paints, insecticides, polish, hair care products, pharmaceuticals, shaving foams, viscous or pasty fluids, water and lubricants.

Several embodiments of the invention will now be described, by way of example only, with reference to the following drawings, in which:

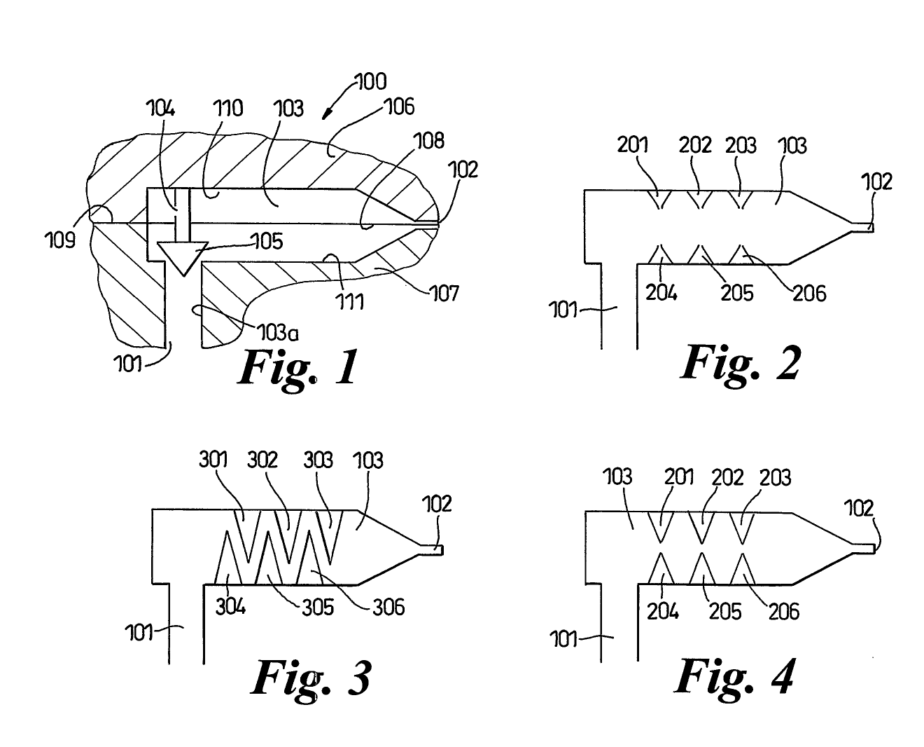

FIG. 1 is a partial cross sectional view though a body of a nozzle arrangement illustrating a first filter arrangement of the invention;

FIG. 2 is a view similar to FIG. 1 illustrating a second filter arrangement of the invention;

FIG. 3 is a view similar to FIG. 1 illustrating a third filter arrangement of the invention;

FIG. 4 is a view similar to FIG. 1 illustrating a fourth filter arrangement of the invention;

FIG. 5 is a view similar to FIG. 1 illustrating a fifth filter arrangement of the invention;

FIG. 5A is a cross-sectional view taken through the filter arrangement shown in FIG. 5;

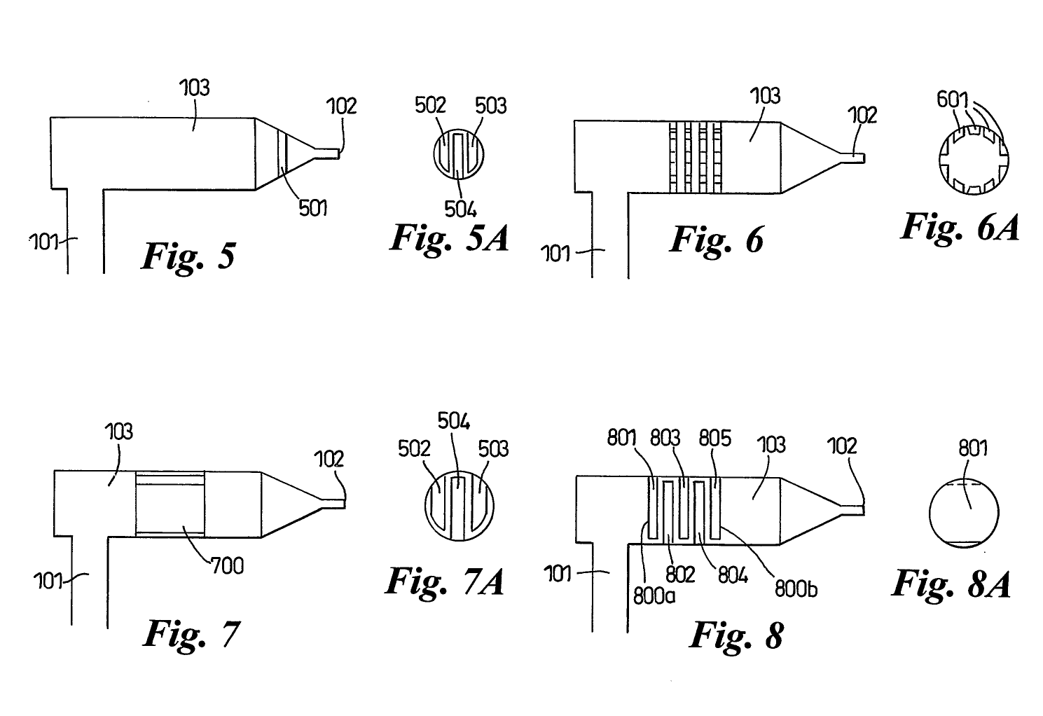

FIG. 6 is a view similar to FIG. 1 illustrating a sixth filter arrangement of the invention;

FIG. 6A is a cross-sectional view taken through the filter arrangement shown in FIG. 6;

FIG. 7 is a view similar to FIG. 1 illustrating a seventh filter arrangement of the invention;

FIG. 7A is a cross-sectional view taken through the filter arrangement shown in FIG. 7;

FIG. 8 is a view similar to FIG. 1 illustrating an eighth filter arrangement of the invention;

FIG. 8A is a cross-sectional view taken through the filter arrangement shown in FIG. 8;

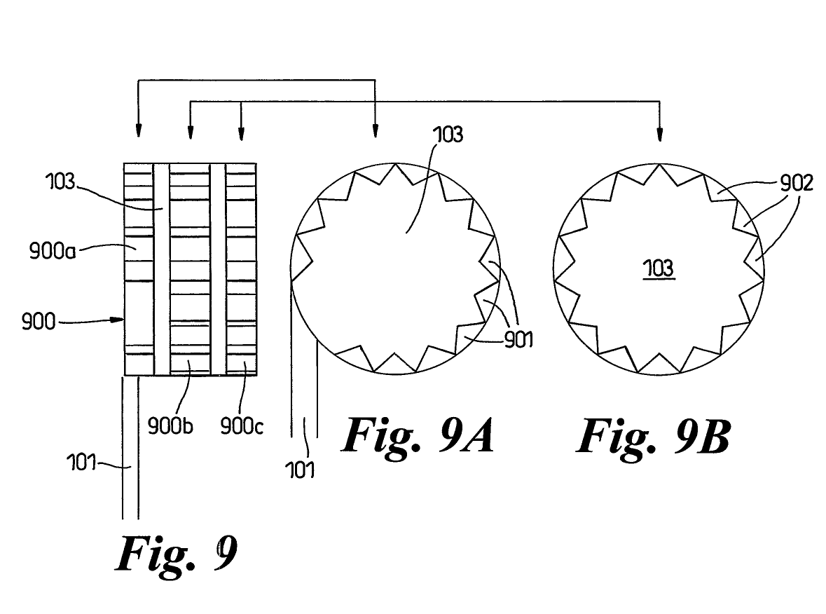

FIG. 9 is a view similar to FIG. 1 illustrating a ninth filter arrangement of the invention; and

FIGS. 9A and 9B are cross-sectional views of the filter arrangement shown in FIG. 9.

In the following description, like reference numerals are used to denote like or corresponding parts in different Figures, where appropriate.

FIG. 1 shows part of a body 100 forming a nozzle arrangement according to the present invention. The 100 body defines an inlet 101, through which fluid may enter, an outlet 102 through which fluid may exit and an internal fluid passageway 103, which connects the inlet 101 and the outlet 102. Positioned within the internal passageway 103 is a filter arrangement which consists of a post 104 having a tapered, cone-shaped head 105. The head extends into the vertical portion 103a of the passageway, as shown, so that fluid flowing through the internal passageway during use is forced to flow between the head 105 and the internal surface of the passageway 103. The head 105 tapers outwards from its point effectively defining a narrowing channel through which the fluid stream must pass. Any particulate matter in the fluid stream that cannot fit through the narrowest portion of the channel defined will become lodged between the head 103 and the internal surface of the passageway 103. As particulate matter accumulates, the available space for fluid to flow through will reduce, causing smaller particulate matter to become lodged.

The body 100 is formed of two component parts 106, 107. Each of the component parts 106, 107 has an abutment surface 108, 109 which abuts the corresponding abutment surface 108, 109 on the other of the parts 106, 107 when they are assembled together to form the body as shown. The two parts 106, 107 also have corresponding formations 110, 111 that define between them a portion of the internal passageway 103 and the outlet 102. In this embodiment the corresponding formations 110, 111 are recesses or grooves in each of the parts which together define the portion of the internal fluid passageway 103 and the outlet 102. In an alternative embodiment, not shown, one of the parts may have a protrusion or ridge that locates within a recess or groove in the other of the parts to define a portion of the internal passageway 103 and the outlet 102. In this arrangement, a gap is present between the outer surface of the protrusion or ridge and the surface of the recess or groove when the parts are assembled. This alternative embodiment can be provided with any of the filter arrangements shown in the present application.

In FIG. 1, only one post 104 is shown projecting from the first part 106 of the body. However, in a further alternative embodiment, not shown, several posts 104 may be provided on the first part 106 of the body with each post entering a recess in the second of the parts 107. All or some of the posts may enter the same recess or each post may enter its own recess.

The filter can be cleaned by separating the two parts 106, 107 of the body, which causes the filter arrangement (the post 104 and head 105) to be withdrawn from the vertical portion 103a of the passageway, enabling any accumulated debris to be removed.

The body 100 may be an integral part of a nozzle arrangement, indeed the two parts 106, 107 may form the whole of the nozzle arrangement between them. Alternatively, the body may form an insert adapted to be received within a main body of the nozzle arrangement.

FIGS. 2 to 8A illustrate alternative filter arrangements that can be used in the body 100. In these Figures, the parts 106, 107 are omitted for simplicity but it will be appreciated that the body is formed in a similar manner to the body 100 shown in FIG. 1.

FIG. 2 shows an alternative filter arrangement comprising tapered projections or posts 201-206. The projections only extend a short distance into the passageway, so only a partial filter is formed around the circumference of the internal passageway. However, as fluid tends to flow around the side of the internal passageway past the projections 201-206 during use, the majority of particulate matter present in the fluid stream will become lodged on the projections. The projections could be smaller or larger than those shown in FIG. 2 and could fill all of the chamber or just a portion thereof. The projections could also be closer and finer nearer to the outlet. Usually the projections will cover the entire surface of the internal passageway.

FIG. 3 shows an alternative nozzle arrangement which is similar to that shown in FIG. 2, except that the tapered projections 301-306 in this instance alternate with projections on the opposing side of the passageway 103 and extend further into the internal passageway so that the tips overlap with one another. Again particulate matter will become lodged on or between the projections 301-306 as fluid flows through. In addition to becoming trapped between adjacent projections, particulate mater can be trapped between the distal ands or tips of the projections and the opposing surface of the internal passage. This increases the effective area of the filter.

FIG. 4 shows a further alternative arrangement, which is the same as the shown in FIG. 2, except that the projections 201-206 extend further into the internal passageway 103 but without overlaping.

FIG. 5 shows an alternative filter arrangement 501. A cross-sectional view of the filter arrangement 501 is shown in FIG. 5A. Referring to FIG. 5A, the filter arrangement 501 comprises downwardly extending projections 502 and 503 and an upwardly extending projection 504. The projections are tapered longitudinally (in the direction of fluid flow through the passageway 103) so that the gap between the projections gradually narrows between the inlet end and the outlet end. Fluid flows through the gaps between the projections during use and any particulate matter that cannot fit through will become lodged in the filter arrangement 501. Larger particles will be lodged at the inlet end of the filter arrangement whereas smaller particles, depending on their size, will become lodged further towards the outlet. In practice, several filter arrangements 501 may be arranged in series along the length of the passage with the gaps present becoming progressively smaller towards the outlet. A small gap is also provided between the end of each of the projections and the surface of the passageway. Fluid can pass through these gaps as well as the gaps between the projections thus increasing the filter area.

FIGS. 6 and 6A show an alternative filter arrangement 600 comprising shorter projections (shown generally as 601). Four separate sets of projection are provided in series along the internal passageway. The projections in each set may be offset relative those of the adjacent sets so that the fluid must move around the projections to pass through the filter. The number of sets can be varied as required.

FIGS. 7 and 7A show a further alternative filter arrangement 700, which is similar to the filter arrangement 501 shown in FIG. 5, except that the projections are longer being in the form of plates or wall like baffles. This allows for a more gradual tapering of the projections 502-504. Again a gap is provided between the ends of the projections and the opposing wall of the internal passageway though which fluid can flow. These gaps can also be arranged to reduce in size from the inlet end to the outlet end.

FIGS. 8 and 8A show a further filter arrangement of the invention. In this embodiment the filter arrangement 800 comprises alternative projections 801-805 which are arranged transversely across the internal passageway. Each projection is in the form of a plate or a wall like baffle extending across the full width of the internal passageway from one side to the other with only a small gap between a distal end of the projection and the opposing surface of the internal passageway. The projections 801, 803, 805 on the first part 106 of the body are interleaved with the projections 802, 804 on the second part 107 so as to define a tortuous flow path through the filter in which the fluid stream is caused to flow through the gap between each projection and the surface of the passageway in turn. In the embodiment shown, the fluid will pass under projection 801, then over projection 802, then under projection 803, then over projection 804 and finally under projection 805. The projections can again be configured so that the gap through which the fluid must flow is larger at the inlet end 800a of the arrangement that the outlet end 800b. Thus the gap between the distal end of the first projection 801 and the surface of the internal passageway will be larger than the gap between the distal end of the last projection 805 and the surface of the internal passageway.

FIG. 9 shows yet another alternative filter arrangement (only the inlet end of the passageway 103 is shown for the purpose of illustration) comprising three filters 900a, 900b and 900c. Referring to FIGS. 9 and 9A, the inlet 101 is arranged so that fluid is introduced tangentially into the passageway 103. This causes the fluid to swirl around the filter 900a. Any particulate matter present in the fluid stream will become lodged in the projections 901 of filter element 900a, or the elements 902 of filters 900b and 900c as the fluid continues to swirl along the passageway towards the outlet. The size and form of the projections in the filters 900a, 900b and 900c can be varied.

The filter arrangements shown in FIGS. 2 to 8 can also be cleaned in a similar manner to the filter arrangement shown in FIG. 1, i.e. by separating the two parts 106, 107 of the body to expose the projections for cleaning.

Some of the aforementioned filter arrangements, especially the arrangement shown in FIG. 5 could be could be used to form a grid at the outlet of a nozzle arrangement adapted to dispense a foam or viscous liquid, such as a cream etc. Such an arrangement is necessary to enhance the quality of the product by preventing potentially abrasive particulates being dispensed.

The body 100 and filter arrangements discussed above are particularly suitable for use with fluids at pressures of 20 bar or less and more particularly with fluid at a pressure in the range of 4 to 12 bar. The parts 106, 107 forming the body 100 may be manufactured from plastics using injection moulding techniques.

The filter arrangements discussed above are produced using filter projections extending from one of the parts 106, 107 of the body which co-operate with further filter formations, projections or recesses, on the other of the parts 106, 107 of the body. This makes it possible to produce more complex and finer filters than is possible using the prior art arrangements in which posts are provided on only one part of a body which defines the internal passageway. For example, in the filters shown in FIGS. 3, 5, 7 & 8, in which filter projections on a first part 106 of the body overlap with filter projections on the other part 107 of the body, the gaps between adjacent overlapping projections can be made very small whist the spacing between the projections on each part is relatively large. This means that the pins used in the mould tool to form the spaces between the projections on each of the parts 106, 107 of the body can be sufficiently large and robust enough to cope with high volume production. Also, in the case of the filters shown in FIGS. 3, 5 and 7, gaps can be provided between or around adjacent projections but also between the distal ends of the projections and the opposing surface of the internal passageway. This enables the effective area of the filter to be increased without increasing the width of the passage or the length of the filter. Furthermore, by providing filter projections on each of the parts 106, 107 of the body, it is possible to construct filters such as that shown in FIG. 8 in which the fluid follows a labyrinthine flow path down around one of the plates and then up and over the next.

Whilst in the embodiments described the filter projections are shown extending from top to bottom of the internal passageway, it will be appreciated that the projections can extend across the passageway in any suitable orientation.

Where the terms “comprise”, “comprises”, “comprised” or “comprising” are used in this specification, they are to be interpreted as specifying the presence of the stated features, integers, steps or components referred to, but not to preclude the presence or addition of one or more other feature, integer, step, component or group thereof.

Whereas the invention has been described in relation to what is presently considered to be the most practical and preferred embodiments, it is to be understood that the invention is not limited to the disclosed arrangements but rather is intended to cover various modifications and equivalent constructions included within the spirit and scope of the invention.

1. A body for a nozzle arrangement for dispensing a fluid in the form of an aerosol, said body defining an inlet, an outlet and an internal passageway that connects said inlet to said outlet; said body comprising two parts configured to be assembled together to form at least part of the body, each of said parts having an abutment surface adapted to contact a corresponding abutment surface on the other of said parts when the parts are assembled, the parts having corresponding formations that co-operate to define between them the outlet and at least a portion of the internal passageway when the parts are assembled;
characterized in that a first of said parts comprises at least one filter projection extending towards a second of said parts, the second of said parts having at least one further filter formation that co-operates with the at least one filter projection to form a filter in the passageway when the parts are assembled.

2. A body for a nozzle arrangement claimed in claim 1, in which the corresponding formations that define the outlet and at least a portion of the internal passageway comprise at least one recess in one of said parts.

3. A body for a nozzle as claimed in claim 2, in which the at least one recess comprises a groove.

4. A body for a nozzle as claimed in claim 2, in which the corresponding formations that define the outlet and at least a portion of the internal passageway comprise at least one projection on the other of said parts, which projection is received in the at least one recess to define at least a portion of the internal passageway when the parts are assembled.

5. A nozzle as claimed in claim 4, in which the at least one projection comprises a ridge.

6. A body for a nozzle arrangement as claimed in claim 2, in which the corresponding formations that define the outlet and at least a portion of the internal passageway comprise at least one further recess in the other of said parts, the at least one further recess aligning with the at least one recess in said one of the parts to define the outlet and at least part of the internal passageway between them.

7. A body for a nozzle arrangement as claimed in claim 6, in which the at least one further recess comprises a groove.

8. A body for a nozzle arrangement as claimed in claim 6 wherein the at least one further filter formation on the second of said parts comprises a recess into which the projection extends.

9. A body for a nozzle arrangement as claimed in claim 8, in which said recess defines the inlet.

10. A body for a nozzle arrangement as claimed in claim 8, in which the first of said parts comprises a plurality of filter projections, each filter projection extending into a corresponding recess formed in the second of said parts when the parts are assembled.

11. A body for a nozzle arrangement as claimed in claim 1, in which the at least one further filter formation comprises at least one filter projection on the second of said parts configured to extend towards the first of said parts when the parts are assembled.

12. A body for a nozzle arrangement as claimed in claim 11, in which a plurality of filter projections are provided on each of said first and second parts.

13. A body for a nozzle arrangement as claimed in claim 12, in which said filter projections project from the corresponding formations that define at least a portion of the internal passageway so as to extend at least part way into the internal passageway when the parts are assembled.

14. A body for a nozzle arrangement as claimed in claim 12, in which the filter projections on each of said first and second parts extend beyond the abutment surface of their respective part.

15. A body for a nozzle arrangement as claimed in claim 14, in which the filter projections on the first and second parts are configured to overlap when the parts are assembled.

16. A body for a nozzle arrangement as claimed in claim 12, in which the filter projections are chosen from a group consisting of:
rods, posts, tubes, flaps, and plates.

17. A body for a nozzle arrangement as claimed in claim 12, in which the filter projections are posts.

18. A body for a nozzle arrangement as claimed in claim 17, in which the posts are tapered, narrowing from a base region to a tip region.

19. A body for a nozzle arrangement as claimed in claim 12 wherein the filter projections are plates.

20. A body for a nozzle arrangement as claimed in claim 19, in which the plates on the first and second parts are interleaved.

21. A body for a nozzle arrangement as claimed in claim 19 wherein the plates are configured to extend longitudinally of the passage when the parts are assembled.

22. A body for a nozzle assembly as claimed in claim 21, in which the plates are tapered so that when the parts are assembled, the gap between adjacent plates narrows from an upstream end of the filter to a down stream end of the filter.

23. A body as claimed in claim 20, in which the plates are configured so as to extend transversely across the passage when the parts are assembled.

24. A body as claimed in claim 23, in which the plates are configured so that the plates extend across the full width of the passage with a gap between a distal end of each plate and the opposing surface of the internal passageway.

25. A body as claimed in claim 24, in which the plates are configured such that the gaps between the distal ends of the plates and the opposing surface of the internal passageway get progressively smaller from an upstream end of the filter to a downstream end of the filter.

26. A body for a nozzle as claimed in claim 1, configured such that, in use, fluid is caused to spin within the internal passageway.

27. A body for a nozzle arrangement as claimed in claim 1 wherein the parts are configured so that when they are assembled, the filter is provided in a portion of the internal passageway that tapers, narrowing from an upstream end of the portion towards a downstream end of the portion.

28. A body for a nozzle arrangement as claimed in claim 1 wherein the two parts are moulded from plastic.

29. A body for a nozzle arrangement as claimed in claim 1 wherein the two parts define the whole of the body.

30. A body for a nozzle arrangement as claimed in claim 1 wherein the body forms an insert configured to be fitted into a nozzle arrangement.

31. A body for a nozzle arrangement as claimed in claim 1 wherein the body comprises the whole of the nozzle arrangement.

32. A body for a nozzle arrangement as claimed in claim 1 wherein said body being configured for use with fluids operating at a pressure of 20 bars or less and especially at a pressure in the range of 4 to 12 bars.

33. (canceled)

34. (canceled)

35. A body for a nozzle arrangement as claimed in claim 20 wherein the plates are configured to extend longitudinally of the passage when the parts are assembled.

36. A body for a nozzle arrangement as claimed in claim 12 configured such that, in use, fluid is caused to spin within the internal passageway.
